(19) United States
(12) Patent Application Publication
(10) Pub. No.: US 2010/0126915 A1
(43) Pub. Date: May 27, 2010

(54) BANKNOTE HANDLING APPARATUS

(75) Inventor: Toyofumi Iwami, Hyogo-ken (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: GLORY LTD, Himeji-shi, Hyogo-ken (JP)

(21) Appl. No.: 12/449,045

(22) PCT Filed: Jan. 22, 2007
(86) PCT No.: PCT/JP2007/050916

§ 371 Date: Dec. 17, 2009

(51) Int. Cl. B07C 5/38

(52) U.S. Cl. 209/534

(57) ABSTRACT

An object is improving handling efficiency of a banknote handling apparatus and reducing operator's work load. A banknote handling apparatus has a receiving unit receiving banknotes, a recognition unit recognizing kinds of banknotes, a first, a second, and a reject stacking units stacking banknotes to be bundled, a batch of banknotes, and rejected banknotes, a transport unit transporting banknotes, a bundling unit bundling banknotes to be bundled, a setting unit setting kinds of banknotes, and a controller performing a transport, a bundling, and a batch controls. In the transport control, banknotes are transported to a destination of transport. In the bundling control, banknotes to be bundled are bundled when a predetermined number of banknotes is stacked in the first stacking unit. In the batch control, temporarily stopping or switching destination of transport is performed when a predetermined number of banknotes to be removed as a batch are stacked in the second stacking unit.

### TECHNICAL FIELD

The present invention relates to a banknote handling apparatus and, more particularly, to a banknote handling apparatus for performing, in a combination, a bundling process of bundling a predetermined number of banknotes and a batch process of sorting banknotes by kinds of the banknotes.

### BACKGROUND ART

In financial institutions and retail shops, a banknote handling apparatus for processing collected banknotes is used. When banknotes of a plurality of denominations including new and old notes are put in an inlet, a conventional banknote handling apparatus recognizes and sorts the banknotes by denominations or new/old.

On the other hand, a banknote handling apparatus disclosed in patent document 1 provides a batch mode (a mode of sorting banknotes of a plurality of denominations by kinds of the banknotes to be removed as a batch for predetermined number) and a bundling mode (a mode of sorting banknotes of a plurality of denominations by kinds of the banknotes of a predetermined number and bundling the banknotes). In the bundling mode, a banknote which is not to be bundled is transported to an external stacking unit. On the other hand, in the batch mode, banknotes are transported depending on fit/unfit and/or new/old.

However, in those banknote handling apparatuses, the batch mode and the bundling mode cannot be implemented simultaneously. Therefore, in the case of processing banknotes and bundling banknotes to be bundled (for example, re-using new notes as changes, and bundling old notes to bring the bundled old notes to a financial institution), at first, the batch mode is set and a batch process is implemented. After that, the setting has to be changed to the bundling mode and, then the bundling process has to be implemented.
[Patent Document 1] Japanese Patent Laid-Open Publication No. 2006-107061

### DISCLOSURE OF THE INVENTION

### Problems to be Solved by the Invention

An object of the present invention is to improve handling efficiency in a banknote handling apparatus in the case of sorting banknotes put in an inlet by kinds of the banknotes and bundling the banknotes of a predetermined number of banknotes, and to reduce work load of operator(s).

### Means for Solving the Problem

According to the present invention, there is provided a banknote handling apparatus comprising:

a receiving unit for receiving banknotes;

a recognition unit for recognizing kinds of the banknotes received by the receiving unit;

a first stacking unit for stacking the banknotes of a predetermined number to be bundled;

a second stacking unit for stacking banknotes of a predetermined number to be removed as a batch and the banknotes can be removed from outside;

a reject stacking unit for stacking rejected banknotes;

a transport unit for transporting banknotes received by the receiving unit to one of the first stacking unit, the second stacking unit, and the reject stacking unit in response to the recognition result of the recognition unit;

a bundling unit for bundling a predetermined number of banknotes stacked in the first stacking unit;

a setting unit for setting kinds of the banknotes to be bundled or kinds of banknotes to be removed as a batch; and

a controller configured to perform a transport control in which the transport unit is controlled to transport the banknotes received by the receiving unit to a predetermined destination of transport based on the setting of the setting unit, a bundling control in which the bundling unit is controlled to bundle the banknotes when a predetermined number of banknotes are stacked in the first stacking unit, and a batch control in which temporarily stopping or switching destination of transport is implemented when a predetermined number of banknotes to be removed as a batch are stacked in the second stacking unit.

### Effect of the Invention

According to the present invention, handling efficiency of a banknote handling apparatus in the case of sorting banknotes put in an inlet by kinds of the banknotes and bundling the banknotes every predetermined number of banknotes can be improved.

### BRIEF DESCRIPTION OF DRAWINGS

FIG. 1 is a vertical cross section schematically showing an internal configuration of a banknote handling apparatus according to an embodiment of the present invention.

FIG. 2 shows an example of a mode setting screen displayed on an operation/display unit 11.

FIG. 3 is a block diagram schematically showing an internal configuration of a controller 400 in the banknote handling apparatus 10 according to the embodiment of the present invention.

FIG. 4 is a flowchart showing a procedure of a control unit 401 in a banknotes stacking process in the embodiment of the present invention.

FIG. 5 is a flowchart showing a procedure of the control unit 401 in a transport control process in the embodiment of the present invention.

FIG. 6 is a flowchart showing a procedure of the control unit 401 in a bundling control process in the embodiment of the present invention.

FIG. 7 is a flowchart showing a procedure of the control unit 401 in a batch control process of a first embodiment of the present invention.

FIGS. 8(a) to (c) are examples of setting data of the first embodiment of the present invention.

FIG. 9 is a flowchart showing a procedure of the control unit 401 in a batch control process of a second embodiment of the present invention.

FIGS. 10(a) to (c) are examples of setting data of the second embodiment of the present invention.

### LIST OF REFERENCE NUMERALS

10 banknote handling apparatus

11 operation/display unit

100 sorting and stacking unit

101 inlet

105 recognition unit

106 reject stacking unit

107 face/back inverting unit

111-115 first stacking units

121,122 second stacking units

130 odd banknote returning unit

131 tray

132 butt member

133 shutter

200 banknote bundling unit

202 rotating mechanism

209 bundled-banknotes ejection port

300 transport unit

301 guide shaft

302 belt

310 elevating unit

311,316 belts

312 block

313,314 hands

315 shaft

400 controller

### BEST MODE FOR CARRYING OUT THE INVENTION

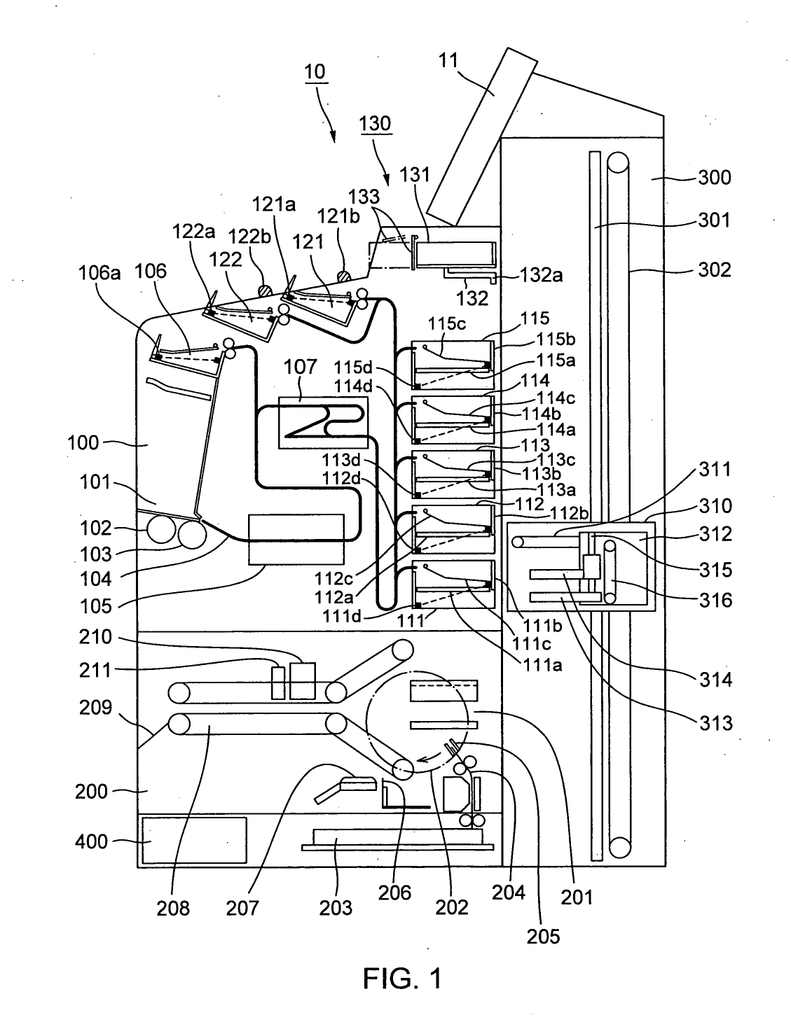

FIG. 1 is a vertical cross section schematically showing an internal configuration of a banknote handling apparatus according to an embodiment of the present invention.

A banknote handling apparatus 10 has an operation/display unit 11 in a top part and is constructed mainly by a sorting and stacking unit 100 in an upper part of the front side, a banknote bundling unit 200 in a lower part of the front side, a transport unit 300 in the rear side, and a controller 400 in a lower part of the banknote bundling unit 200.

### (Sorting and Stacking Unit 100)

The sorting and stacking unit 100 is a part for sorting and stacking banknotes. On an almost center part of the front panel, an inlet 101 for receiving banknotes to be handled is provided. The banknotes to be handled, the banknotes being put in the inlet 101, are fed by feed rollers 102 and 103 and transported along a transport path 104.

A recognition unit 105 is provided in some midpoints of the transport path 104. The banknotes transported along the transport path 104 pass through the recognition unit 105 where the kinds of the banknote (denomination, fit/unfit, genuine/counterfeit, face/back, and new/old) are recognized.

The transport path 104 is branched after the recognition unit 105. According to a recognition result (fit/unfit or genuine/counterfeit) by the recognition unit 105, old banknotes, unfit notes, counterfeit notes, and the like are stacked in a reject stacking unit 106 as rejected notes, and some of fit and genuine notes are inverted by a face/back inverting unit 107 so that the face/back sides of all of the banknotes become the same. Further, in response to the recognition result (denomination), banknotes to be bundled are stacked in any of first stacking units 111 to 115 for storage. In second stacking units 121 and 122, banknotes to be removed as a batch are stacked. Banknotes to be removed as a batch denote banknotes satisfying predetermined conditions and sorted for predetermined number of banknotes, which can be taken out from the outside. The predetermined number is usually 100 and may be fixedly preset or may be set to an arbitrary value (for example, an arbitrary value of 200, 50, 25, or the like) by the operator.

The first stacking units 111 to 115 have stages 111a to 115a for stacking and can be moved in the vertical direction by driving units (not shown), respectively. In FIG. 1, the first stacking units 111 to 115 are shown in a state where banknotes can be stacked. That is, since the stages 111a to 115a are positioned in the positions of lower ends of wall members 111b to 115b provided at about a portion of ⅔ of height from the upper side, transported banknotes come into contact with the wall members 111b to 115b, and are stopped and stacked in the first stacking units 111 to 115. In order to prevent jump-out of banknotes and to ensure stable stacking at this time, retainer plates 111c to 115c which can swing according to a stacked amount are provided. In the stages 111a to 115a and the wall members 111b to 115b, notches through which a hand of a transport unit described later can freely pass are formed. The banknotes to be removed by a batch are further transported and stacked in the second stacking units 121 and 122.

The reject stacking unit 106, the first stacking units 111 to 115, and the second stacking units 121 and 122 have a pair of remaining-banknote detecting sensors 106a, 111d to 115d, 121a, and 122a, respectively. The remaining-banknote detecting sensors are optical sensors for detecting the presence or absence of a remaining banknote.

The second stacking units 121 and 122 have notifying units 121b and 122b, respectively, for notifying of the fact that the number of stacked banknotes reaches a predetermined number (urging the operator to remove banknotes as a batch). The notifying units 121b and 1221b warn the operator by characters, images, light, sound, or the like and take of forms of, for example, liquid crystal displays, LED lamps, loud speakers, or the like.

When the operator enters settings using keys (not shown) of the operation/display unit 11, this unit functions as a setting unit to set variety of objects to be stacked in the first stacking units 111 to 115, in the second stacking units 121 and 122, and in the reject stacking unit 106. By this function, various handlings can be implemented. For example, a setting can be made in a combination of kinds such as denominations, fit/unfit, and new/old. The operation/display unit 11 also has a function of a notifying unit for notifying the operator of various information via a display (not shown).

Under the operation/display unit 11, an odd banknote returning unit 130 for returning odd banknotes which became objects to be bundled but the number of banknote did not reach the number to be bundled is provided. When the rear side of a front end part 132a of a butt member 132 provided on the under face of an odd banknote returning tray 131 is pressed, the odd banknote returning tray 131 moves forward, a shutter 133 provided at the front is opened, the odd banknote returning tray 131 advances to a position indicated by an alternate long and short dash line, and the odd banknotes can be taken out.

### (Banknote Bundling Unit 200)

The banknote bundling unit 200 is a part for bundling (for bundling banknotes by winding the banknotes with a paper band) a predetermined number (usually, 100) of banknotes.

In the first stacking units 111 to 115, stacked banknotes whose number has reached the predetermined number are transferred by the transport unit 300 to a setting unit 201 and gripped. A rotating mechanism 202 for winding a bundling tape around a predetermined portion of the gripped banknotes is provided. The tip of a bundling tape 204 taken from a bundling tape stacking unit 203 is retained by a tape retainer 205 and, by rotation, bundled banknotes are obtained. A cutter 206 for cutting the tip of the tape after the bundling and a heater 207 for thermally bonding the tip after the bundling are also provided. The bundled banknotes are ejected to a bundled-banknotes ejection port 209 by a belt-type transport mechanism 208. In some midpoints of the transport, a printing unit 210 for printing denomination, time and date, serial number, and the like on the bundle and a sealing unit 211 for impressing a seal of the financial institute that implemented the handling are provided.

### (Transport Unit 300)

The transport unit 300 transports banknotes to be bundled or odd banknotes between the first stacking units 111 to 115 and the banknote bundling unit 200 or the odd banknotes returning unit 130. The transport unit 300 has a guide shaft 301 mounted perpendicularly from the lower end to the upper end of the apparatus, an elevating unit 310 which can move in the vertical direction with being engaged with the guide shaft 301, and a drive belt 302 for making the elevating unit 310 move in the vertical direction.

The elevating unit 310 has a block 312 which can be moved in the forward/backward directions by a belt mechanism 311. The block 312 has a fixed lower hand 313 and an upper hand 314 moved in the vertical direction along a shaft 315 by a belt 316. The hands 313 and 314 are provided to grip and take out banknotes to be bundled or odd banknotes stacked in the first stacking units 111 to 114, and to transfer the banknotes to be bundled or odd banknotes to the banknote bundling unit 200 or the odd banknotes returning unit 130.

### (Controller 400)

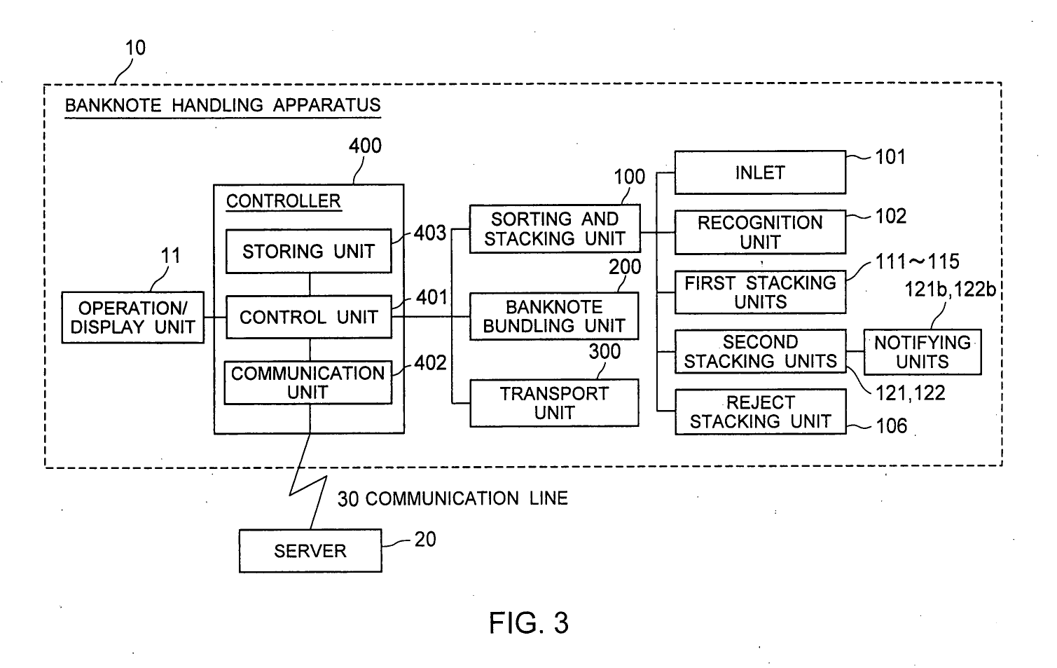

The controller 400 is a part for controlling the whole operation of the banknote handling apparatus 10. Though, in FIG. 1, the controller 400 is drawn under the banknote bundling unit 200 for convenience, the controller 400 can be mounted in any place in the apparatus as long as the place is a secured space in designing. The details will be described later (refer to FIG. 3).

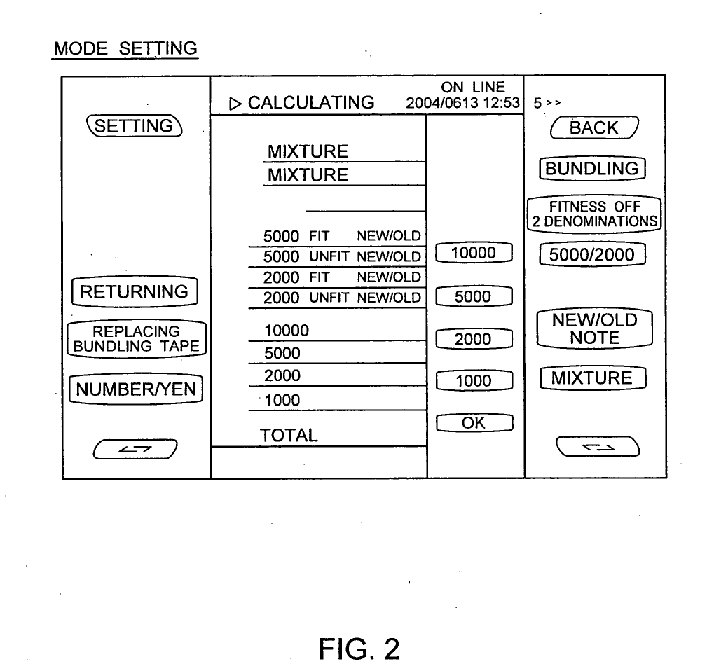

FIG. 2 shows an example of a mode setting screen displayed on the operation/display unit 11, which is a screen appeared when a setting button at the top position in the leftmost column is pressed. The screen is a touch sensing panel. Various operations can be implemented by touches of the operator on corresponding places in the screen.

By pressing various setting buttons provided in the column at the left end and in the two columns at the right end in the screen, the denomination, the kind of banknote, and the kind of printing can be designated by the first stacking units 111 to 115, the second stacking units 121 and 122, and the reject stacking unit 106.

The second column from the left expresses the settings of each stacking unit and handled amount of money. Two rows at the top show settings to the second stacking units 121 and 122, and the following four rows show settings to the first stacking units 111 to 115. The third stacking unit 115 is used to stack banknotes which cannot be stacked.

In the example shown in FIG. 2, mixture is set in both of the two second stacking units 121 and 122. In the four first stacking units 111 to 114, mixture of fit and old notes and fit and new notes of 5,000 yen, mixture of unfit and old notes and unfit and new notes of 5,000 yen, mixture of fit and old notes and fit and new notes of 2,000 yen, and mixture of unfit and old notes and unfit and new notes of 2,000 yen are set, respectively. In the part below the display of the settings, amount of money of the banknotes actually received and the total amount are shown.

FIG. 3 is a block diagram schematically showing the internal configuration of the controller 400 in the banknote handling apparatus 10 according to the embodiment of the present invention.

The controller 400 in the banknote handling apparatus 10 has the control unit 401, communication unit 402, and storing unit 403. As an example, the control unit 401 is a microprocessor, the communication unit 402 is a communication interface which can be connected to the communication line 30 (for example, intranet), and the storing unit 403 is a computer-readable storing medium such as a RAM.

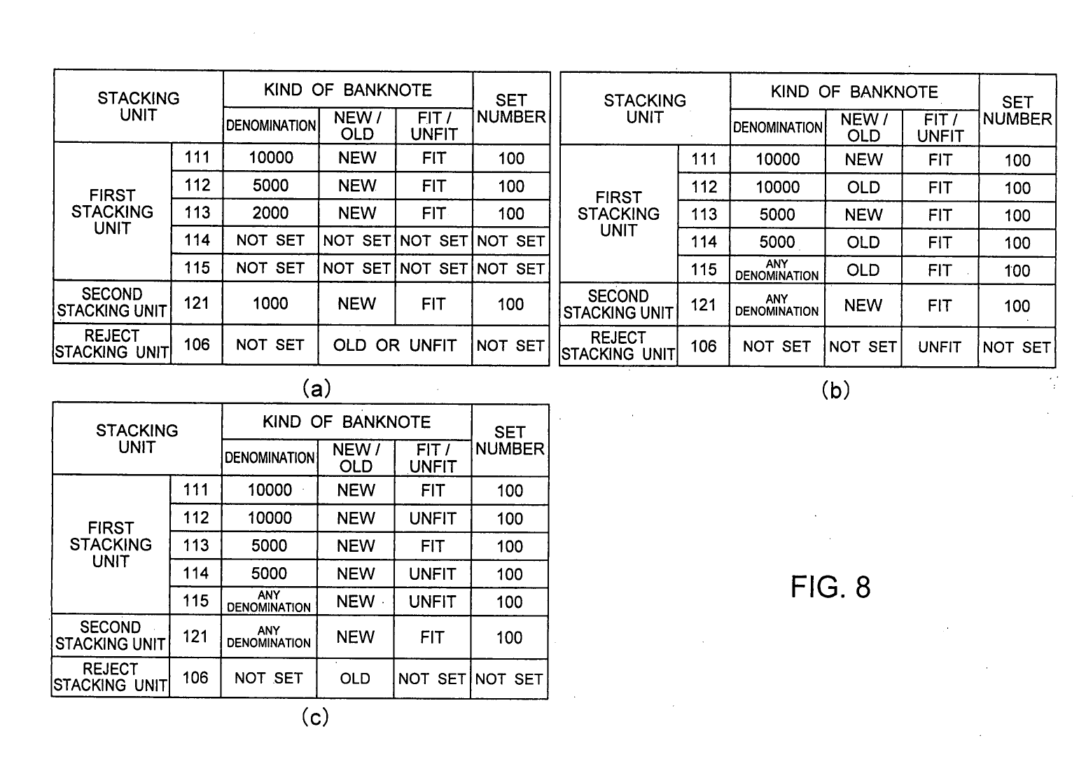

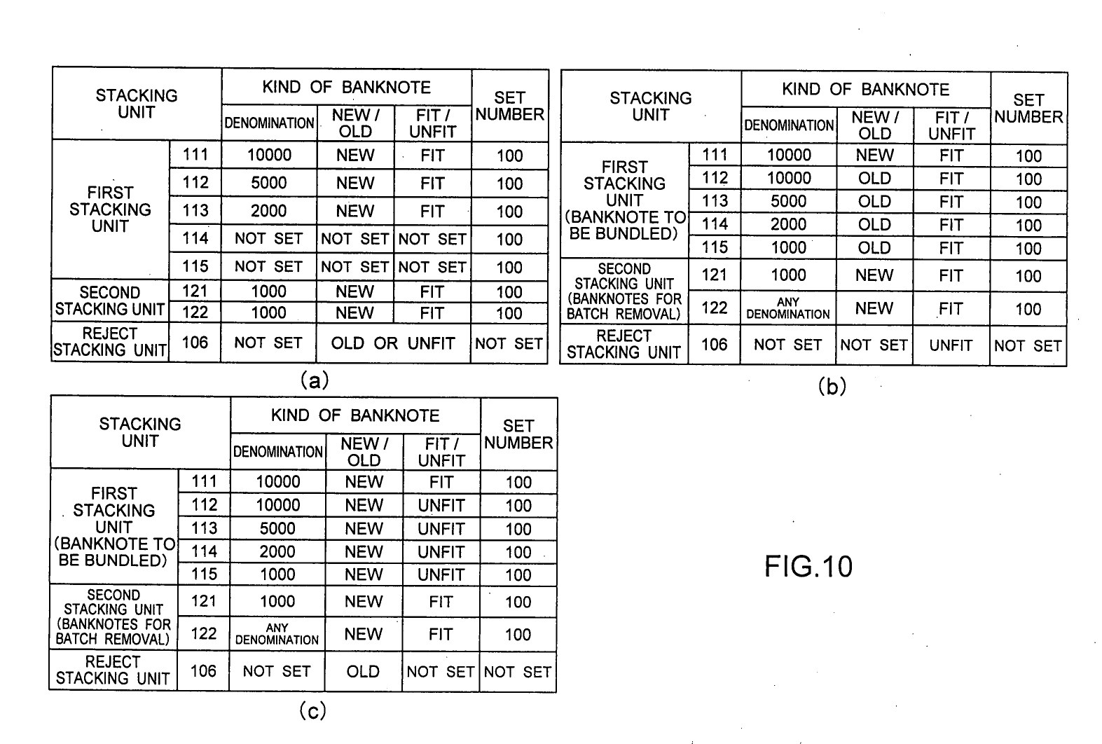

The control unit 401 controls the operation/display unit 11, the sorting and stacking unit 100, the banknote bundling unit 200, and the transport unit 300. The communication unit 402 is connected to the server 20 (for example, a higher-ranking computer installed in the center of a financial institute or the like) via the communication line 30. The storing unit 403 stores various data (for example, a control program for the control unit 401, setting data which is set via the operation/display unit 11 (refer to FIGS. 8(a) to 8(c) and FIGS. 10(a) to 10(c)), image data of a notification screen to be displayed on the operation/display unit 11, and data indicative of the number of banknotes stacked in the sorting and stacking unit 100).

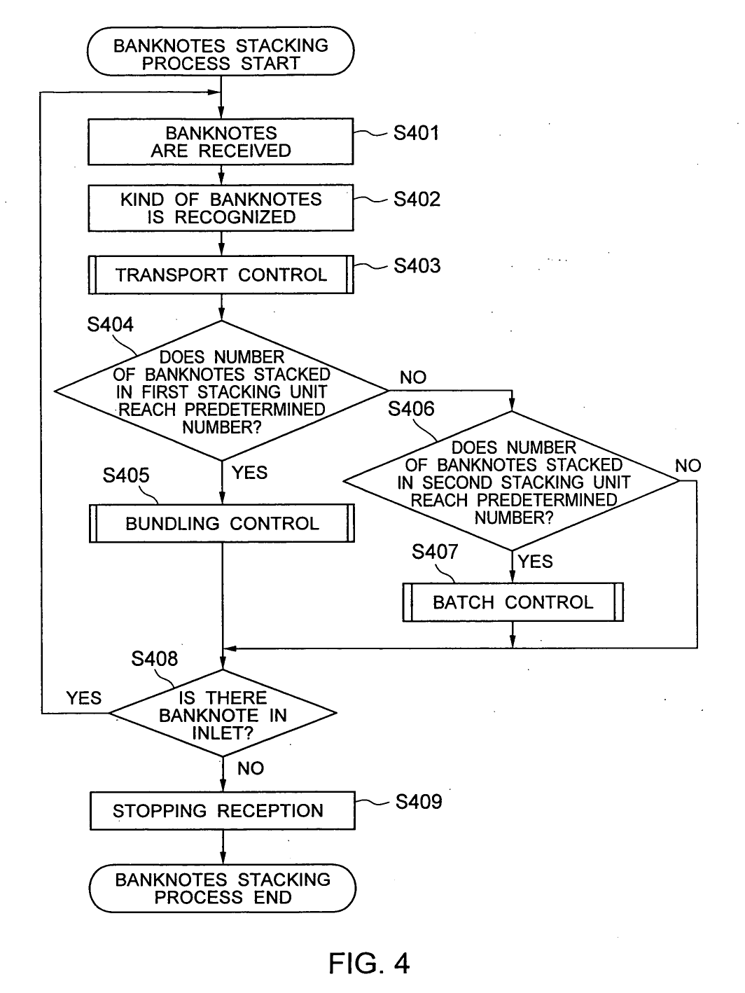

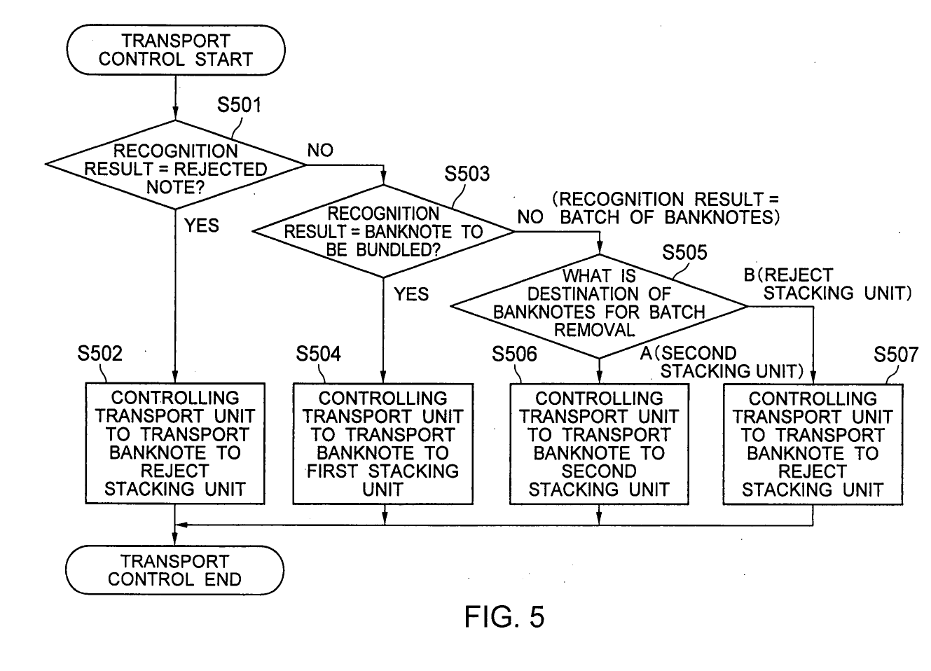

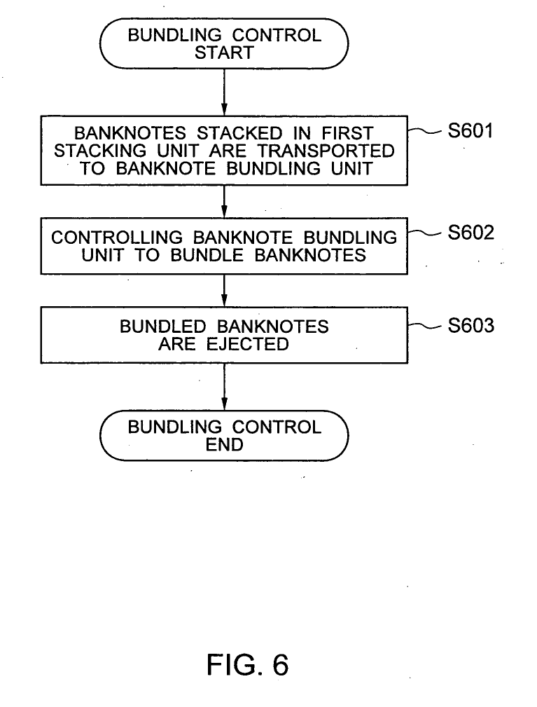

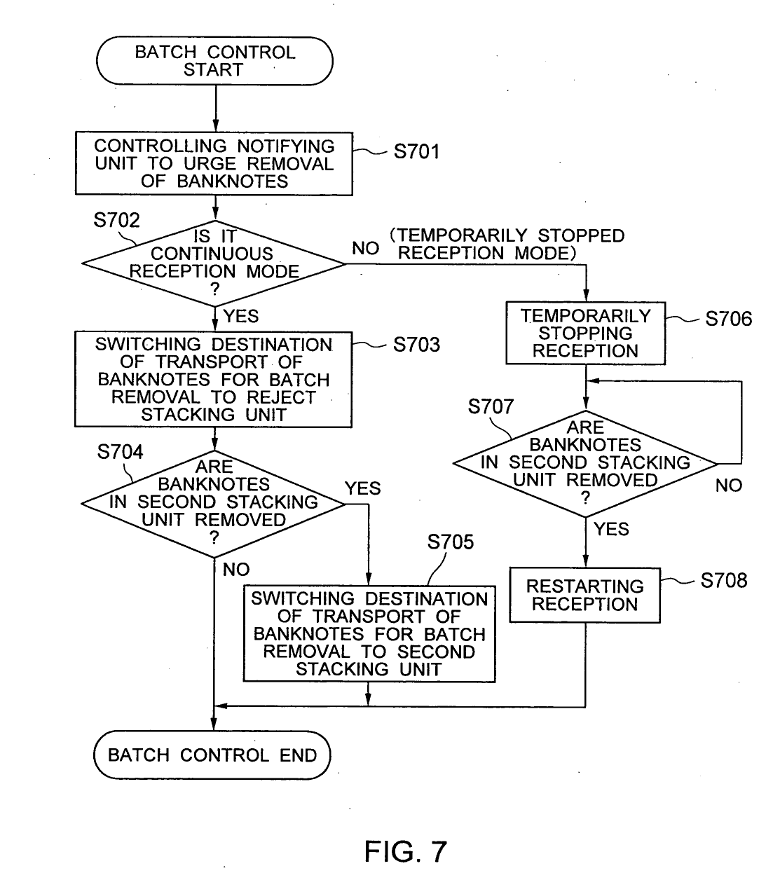

In the embodiment of the present invention, by starting the control program stored in the storing unit 403, the control unit 401 performs a banknote stacking process (refer to FIG. 4), a transport control process (refer to FIG. 5), a bundling control process (refer to. FIG. 6), and a batch control process (refer to FIG. 7 or 8) which will be described later.

FIG. 4 is a flowchart showing a procedure of the control unit 401 in a banknotes stacking process in the embodiment of the present invention.

First, the control unit 401 controls the feeding rollers 102 and 103, thereby banknotes put in the inlet 101 is received and transported along the transport path 104 (S401). Then, the control unit 401 controls the recognition unit 105 provided in some midpoints of the transport path 104, thereby the kinds (denomination, fit/unfit, genuine/counterfeit, face/back, and new/old) of the banknotes are recognized (S402). Then, a transport control (refer to FIG. 5) which will be described later is implemented (S403).

In the case where, as a result of the transport control (S403), the number of banknotes stacked in the first stacking units 111 to 115 reaches the predetermined number (Yes in S404), a bundling control (refer to FIG. 6) which will be described later is implemented (S405), and the procedure advances to S408. In the case where, as a result of the transport control (S403), the number of banknotes stacked in the second stacking units 121 and 122 reaches the predetermined number (No in S404 and Yes in S406), a batch control (refer to FIG. 7 or 8) which will be described later is implemented (S407), and the procedure advances to S408. On the other hand, in the case where, as a result of the transport control (S403), the numbers of banknotes stacked in the second stacking units 121 and 122 have not reached the predetermined number (No in S404 and No in S406), the procedure advances to S408.

Then, when there is a banknote in the inlet 101 (Yes in S408), the procedure returns to S401. On the other hand, when there is no banknote in the inlet 101 (No in S408), receiving banknotes from the inlet 101 is stopped (S409), and the banknote stacking process is finished.

FIG. 5 is a flowchart showing a procedure of the control unit 401 in the transport control process in the embodiment of the present invention. The transport control process is implemented subsequent to S402 in FIG. 4.

First, in the case where the recognition result in S402 is a rejected banknote (Yes in S501), the control unit 401 controls the transport unit 300 to transport the rejected banknote to the reject stacking unit 106 (S502).

In the case where the recognition result in S402 is banknotes are to be bundled (No in S501 and Yes in S503), the control unit 401 controls the transport unit 300 to transport the banknotes to any of the first stacking units 111 to 115 (S504). At this time, the control unit 401 determines, as a destination of transport, any of the first stacking units 111 to 115 with reference to the setting data stored in the storing unit 403 (any of FIGS. 8(a) to 8(c) and FIGS. 10(a) to 10(c)).

On the other hand, in the case where the recognition result in S402 is banknotes to be removed as a batch (No in S501 and No in S503), the control unit 401 controls the transport unit 300 to transport the banknotes for batch removal to a destination of the banknotes for batch removal. That is, when the destination of the banknotes for batch removal is the second stacking unit 121 or 122 (A in S505), the control unit 401 controls the transport unit 300 to transport the banknotes for batch removal to any of the second stacking units 121 and 122 (S506). When the destination of the banknotes for batch removal is the reject stacking unit 106 (B in S505), the control unit 401 controls the transport unit 300 to transport the banknotes for batch removal to the reject stacking unit 106 (S507). At this time, the control unit 401 normally determines any of the second stacking units 121 and 122 as the destination of transport of the banknotes for batch removal with reference to the setting data stored in the storing unit 403 (any of FIGS. 8(a) to 8(c) and FIGS. 10(a) to 10(c)). When the destination of transport of the banknotes for batch removal is switched to the reject stacking unit 106 in the batch control (refer to FIG. 7 or 8) which will be described later, the control unit 401 determines the reject stacking unit 106 as the destination of transport of the banknotes for batch removal.

After the step in any of S502, S504, S506, and S507 is finished, the transport control is finished and the procedure advances to S404 in FIG. 4.

FIG. 6 is a flowchart showing a procedure of the control unit 401 in the bundling control process in the embodiment of the present invention. The bundling control process is implemented in the case where the number in any of the first stacking units 111 to 115 has reached the predetermined number (Yes in S404).

First, the control unit 401 controls the transport unit 300 to transport banknotes stacked in any of the first stacking units 111 to 115, the number of the banknotes having reached the predetermined number, to the banknote bundling unit 200 (S601). Then, the control unit 401 controls the banknote bundling unit 200 to bundle the banknotes (S602). Then, the bundled banknotes are ejected from the bundled-banknotes ejecting port 209 (S603). After completion of the step in S603, the bundling control is finished and the procedure advances to S408 in FIG. 4.

### First Embodiment

Next, a first embodiment of the present invention will be described. In the first embodiment of the present invention, the case where the banknote handling apparatus 10 has one second stacking unit (that is, only the second stacking unit 121) will be described.

FIG. 7 is a flowchart showing a procedure of the control unit 401 in the batch control process of the first embodiment of the present invention. The batch control process of the first embodiment of the present invention is implemented in the case where the number of banknotes stacked in the second stacking unit 121 has reached the predetermined number in S406 in FIG. 4 (Yes in S406).

First, the control unit 401 controls the notifying unit 121b to urge removal of banknotes (S701).

In the case where a “continuous reception mode” is set (Yes in S702), the control unit 401 switches the destination of transport of the banknotes for batch removal to the reject stacking unit 106 (S703). In the case where the banknotes stacked in the second stacking unit 121 are removed (Yes in S704), the control unit 401 switches the destination of transport of the banknotes for batch removal to the second stacking unit 121 (S705), and the batch control process is finished. On the other hand, when the banknotes stacked in the second stacking unit are not removed (No in S704), in a state where the reject stacking unit 106 is set as the destination of transport of the banknotes for batch removal, and the batch control process is finished.

In the case where a “temporarily stopped reception mode” is set (No in S702), the control unit 401 temporarily stops receiving banknotes from the inlet 101 (S706). Then, the control unit 401 maintains the temporary stop state until the banknotes stacked in the second stacking unit 121 are removed (No in S707). After the banknotes stacked in the second stacking unit 121 are removed (Yes in S707), the control unit 401 restarts receiving banknotes from the inlet 101 (S708), and the batch control process is finished.

FIGS. 8(a) to 8(c) show an example of the setting data of the first embodiment of the present invention. The setting data is set by the operator via the operation/display unit 11 and stored in the storing unit 403.

FIG. 8(a) shows setting data in the case of sorting 100 new and fit banknotes to the first stacking units 111 to 113 by denominations of banknotes (banknote of 10,000 yen, banknote of 5,000 yen, and banknote of 2,000 yen), sorting 100 new and fit banknotes of 1,000 yen to the second stacking unit 121, and sorting an old or unfit banknote to the reject stacking unit 106.

In the case of setting the setting data of FIG. 8(a), a new and fit banknote of 1,000 yen can be taken out for a change, and banknotes of the other denominations can be bundled.

FIG. 8(b) shows setting data in the case of sorting 100 fit banknotes to the first stacking units 111 to 115 by denominations and new/old notes, sorting 100 new and fit banknotes of any denominations to the second stacking unit 121, and sorting an unfit banknote to the reject stacking unit 106. In the case of setting the setting data of FIG. 8(b), a new and fit banknote can be taken out for a change, and banknotes of the other denominations can be bundled by new/old notes.

FIG. 8(c) shows setting data in the case of sorting 100 new banknotes to the first stacking units 111 to 115 by denominations and fit/unfit banknotes, sorting 100 new and fit banknotes of any denominations to the second stacking unit 121, and sorting an old banknote to the reject stacking unit 106. In the case of setting the setting data of FIG. 8(c), a new and fit banknote can be taken out for a change, and banknotes of the other denominations can be bundled by fit/unfit notes.

According to the first embodiment of the present invention, in the case where banknotes to be bundled and banknotes for batch removal are mixedly put in the inlet 101, and the bundling process and the batch process are implemented at once, even when the number of the banknotes for batch removal stacked in the second stacking unit 121 reaches the predetermined number, the handling can be continued without stopping reception of banknotes from the inlet 101. As a result, the handling efficiency of the banknote handling apparatus 10 for sorting banknotes to be bundled and a removal of banknotes as a batch can be improved.

In the case where the temporarily stopped reception mode is set, when the number of the banknotes for batch removal reaches the predetermined number, reception of banknotes from the inlet 101 is temporarily stopped and is not restarted until the banknotes for batch removal is removed by the operator. Consequently, a batch of banknotes and a rejected banknote do not mixedly exist in the reject stacking unit 106.

Notification to the operator via the notifying unit 121a can urge the operator to remove a batch of banknotes whose number has reached the predetermined number. As a result, the work efficiency of the operator can be improved.

### Second Embodiment

Next, a second embodiment of the present invention will be described. In the first embodiment of the present invention, the case where the banknote handling apparatus 10 has one second stacking unit (that is, only the second stacking unit 121) has been described. In the second embodiment of the present invention, the case where the banknote handling apparatus 10 has a plurality of second stacking units 121 and 122 will be described.

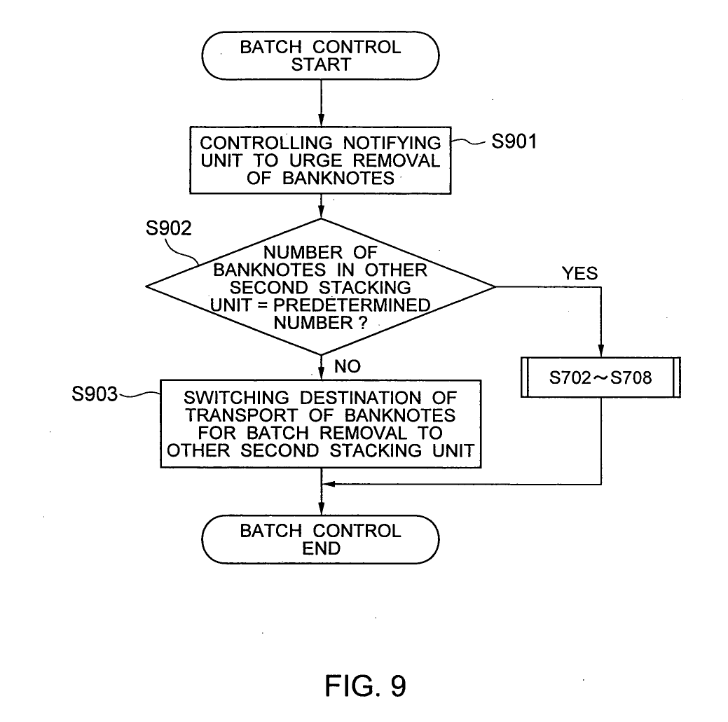

FIG. 9 is a flowchart showing a procedure of the control unit 401 in the batch control process of the second embodiment of the present invention. The batch control process of the second embodiment is a process implemented in the case where the number of banknotes stacked in any of the second stacking units 121 and 122 has reached the predetermined number in S406 in FIG. 4 (Yes in S406). The case where the number of banknotes stacked in the second stacking unit 121 has reached the predetermined number will be described below.

First, the control unit 401 controls the notifying unit 121b to urge removal of banknotes (S901).

Then, in the case where the number of banknotes stacked in the other second stacking unit (second stacking unit 122) has not reached the predetermined number (No in S902), the control unit 401 switches the destination of stacking of a batch of banknotes to the other second stacking unit (second stacking unit 122) (S903), and the batch control process is finished.

On the other hand, in the case where the number of banknotes stacked in the other second stacking unit (second stacking unit 122) has reached the predetermined number (Yes in S902), the control unit 401 performs steps similar to those in S702 to S708 in FIG. 7, and the batch control process is finished.

FIGS. 10(a) to 10(c) show an example of the setting data of the second embodiment of the present invention. The setting data is set by the operator via the operation/display unit 11 and stored in the storing unit 403.

FIG. 10(a) shows setting data in the case of sorting 100 new and fit banknotes to the first stacking units 111 to 113 by denominations of banknotes (banknote of 10,000 yen, banknote of 5,000 yen, and banknote of 2,000 yen), sorting 100 new and fit banknotes of 1,000 yen to the second stacking units 121 and 122, and sorting an old or unfit banknote to the reject stacking unit 106. In the case of setting the setting data of FIG. 10(a), a banknote of 1,000 yen can be taken out for a change, and banknotes of the other denominations can be bundled. In the case where the number of banknotes of 1,000 yen for a change stacked in the second stacking unit 121 reaches 100, the subsequent banknotes of 1,000 yen for a change can be stacked in the second stacking unit 122.

FIG. 10(b) shows setting data in the case of sorting 100 fit banknotes to the first stacking units 111 to 115 by denominations and new/old notes, sorting 100 new and fit banknotes of 1,000 yen to the second stacking unit 121, sorting 100 new and fit banknotes of any denominations to the second stacking unit 122, and sorting an unfit banknote to the reject stacking unit 106. In the case of setting the setting data of FIG. 10(b), a new and fit banknote can be taken out for a change, and banknotes of the other denominations can be bundled by new/old notes. In the case where the number of banknotes of 1,000 yen for a change stacked in the second stacking unit 121 reaches 100, the subsequent banknotes of 1,000 yen for a change can be stacked in the second stacking unit 122.

FIG. 10(c) shows setting data in the case of sorting 100 new banknotes to the first stacking units 111 to 115 by denominations and fit/unfit banknotes, sorting 100 new and fit banknotes to the second stacking unit 121, sorting 100 new and fit banknotes of any denominations to the second stacking unit 122, and sorting an old banknote to the reject stacking unit 106. In the case of setting the setting data of FIG. 10(c), a new and fit banknote can be taken out for a change, and banknotes of the other denominations can be bundled by fit/unfit notes. In the case where the number of banknotes of 1,000 yen for a change stacked in the second stacking unit 121 reaches 100, the subsequent banknotes of 1,000 yen for a change can be stacked in the second stacking unit 122.

According to the second embodiment of the present invention, in addition to effects similar to those of the first embodiment of the present invention, even when the number of batch of banknotes stacked in the second stacking unit 121 reaches a predetermined number, a batch of banknotes can be transported to the other second stacking unit (second stacking unit 122). As a result, the handling efficiency of the banknote handling apparatus 10 at the time of sorting banknotes to be bundled and a batch removal of banknotes can be improved more than the first embodiment of the present invention.

By notification to the operator via the notifying units 121b and 122b, the operator can be explicitly notified of which the number of banknotes stacked in one of the second stacking units 121 and 122 has reached the predetermined number.

1. A banknote handling apparatus comprising:
a receiving unit for receiving banknotes;
a recognition unit for recognizing kinds of the banknotes received by the receiving unit;
a first stacking unit for stacking the banknotes of a predetermined number to be bundled;
a second stacking unit for stacking the banknotes of a predetermined number to be removed as a batch and the banknotes can be removed from outside;
a reject stacking unit for stacking rejected banknotes;
a transport unit for transporting banknotes received by the receiving unit to one of the first stacking unit, the second stacking unit, and the reject stacking unit in response to the recognition result of the recognition unit;
a bundling unit for bundling a predetermined number of banknotes stacked in the first stacking unit;
a setting unit for setting kinds of the banknotes to be bundled or kinds of the banknotes to be removed as a batch; and
a controller configured to implement a transport control in which the transport unit is controlled to transport the banknotes received by the receiving unit to a predetermined destination of transport based on the setting of the setting unit, a bundling control in which the bundling unit is controlled to bundle the banknotes when a predetermined number of banknotes are stacked in the first stacking unit, and a batch control in which temporarily stopping or switching destination of transport is implemented when a predetermined number of banknotes to be removed as a batch are stacked in the second stacking unit.

2. The banknote handling apparatus according to claim 1, wherein when a predetermined number of banknotes to be removed as a batch are stacked in the second stacking unit, the controller is configured to temporarily stop the receiving unit to receive banknotes, and to restart to receive banknotes after the predetermined number of banknotes have been removed from the second stacking unit.

3. The banknote handling apparatus according to claim 1, wherein when a predetermined number of banknotes to be removed as a batch are stacked in the second stacking unit, the controller is configured to perform the batch control in which the destination of transport of the banknotes to be removed as a batch is switched to the reject stacking unit, and after the banknotes have been removed from the second stacking unit, the destination of transport of the banknotes is switched to the second stacking unit.

4. The banknote handling apparatus according to claim 1, wherein the second stacking unit is comprised of a plurality of the second stacking units and
when a predetermined number of the banknotes are stacked in one of the second stacking units and banknotes can be stacked in one of another second stacking units, the controller controls the batch control to switch the destination of transport of the banknotes to the one of another second stacking units.

5. The banknote handling apparatus according to claim 1, wherein the second stacking units is comprised of a plurality of stacking units, and
the setting unit is configured to set kinds of the banknotes and the number of the kinds of the banknotes to be removed as a batch is less than or equal to the number of the second stacking units.

6. The banknote handling apparatus according to claim 1, further comprising:
a notifying unit for urging operator to remove the banknotes as a batch, which are stacked in the second stacking unit;
wherein when a predetermined number of the banknotes for batch removal are stacked in the second stacking unit, the controller controls the notifying unit to urge the operator to remove the batch of the banknotes as a batch.

7. (canceled)

8. (canceled)

9. (canceled)

10. The banknote handling apparatus according to claim 2, wherein the second stacking units is comprised of a plurality of stacking units, and
the setting unit is configured to set kinds of the banknotes and, the number of the kinds of the banknotes to be removed as a batch is less than or equal to the number of the second stacking units.

11. The banknote handling apparatus according to claim 3, wherein the second stacking units is comprised of a plurality of stacking units, and
the setting unit is configured to set kinds of the banknotes and, the number of the kinds of the banknotes to be removed as a batch is less than or equal to the number of the second stacking units.

12. The banknote handling apparatus according to claim 2, further comprising:
a notifying unit for urging operator to remove the banknotes as a batch, which are stacked in the second stacking unit;
wherein when a predetermined number of the banknotes for batch removal are stacked in the second stacking unit, the controller controls the notifying unit to urge the operator to remove the batch of the banknotes as a batch.

13. The banknote handling apparatus according to claim 3, further comprising:
a notifying unit for urging operator to remove the banknotes as a batch, which are stacked in the second stacking unit;
wherein when a predetermined number of the banknotes for batch removal are stacked in the second stacking unit, the controller controls the notifying unit to urge the operator to remove the batch of the banknotes as a batch.

14. The banknote handling apparatus according to claim 4, further comprising:
a notifying unit for urging operator to remove the banknotes as a batch, which are stacked in the second stacking unit;
wherein when a predetermined number of the banknotes for batch removal are stacked in the second stacking unit, the controller controls the notifying unit to urge the operator to remove the batch of the banknotes as a batch.

15. The banknote handling apparatus according to claim 1, wherein the setting unit is configured to set at least one of a denomination, new/old, and fit/unfit as the kinds of the banknotes.

16. The banknote handling apparatus according to claim 2, wherein the setting unit is configured to set at least one of a denomination, new/old, and fit/unfit as the kinds of the banknotes.

17. The banknote handling apparatus according to claim 3, wherein the setting unit is configured to set at least one of a denomination, new/old, and fit/unfit as the kinds of the banknotes.

18. The banknote handling apparatus according to claim 4, wherein the setting unit is configured to set at least one of a denomination, new/old, and fit/unfit as the kinds of the banknotes.
